(19) United States
(12) Patent Application Publication
(10) Pub. No.: US 2016/0150806 A1
(43) Pub. Date: Jun. 2, 2016

(54) Encapsulated aquaculture premix feed

(71) Applicant: Integrated Aquaculture International, LLC, St. Louis, MO (US)

(72) Inventors: George W. Chamberlain, St. Louis, MO (US); Anant S. Bharadwaj, Chesterfield, MO (US)

(21) Appl. No.: 14/928,705

(22) Filed: Oct. 30, 2015

Related U.S. Application Data
(60) Provisional application No. 62/073,210, filed on Oct. 31, 2014.

(51) Int. Cl. A23K 1/16; A01K 61/00; A23K 1/18

(52) U.S. Cl. CPC A23K 1/004; A23K 1/164; A23K 1/1634; A23K 1/188; A01K 61/005; A01K 61/00

(57) ABSTRACT

An aquaculture premix and a method of manufacturing a granulated or powdered aquaculture premix are provided.

### CROSS REFERENCE TO RELATED APPLICATION

The present application is based on and claims the benefit of U.S. provisional patent application Ser. No. 62/073,210, filed Oct. 31, 2014, the content of which is hereby incorporated by reference in its entirety.

### FIELD

The present disclosure relates to a component of aquaculture feeds. More particularly, the present disclosure relates to a component of an analog aquaculture feed ingredient or of a complete aquaculture feed that provides the same or similar nutrition to that of a typical, commonly used aquaculture feed ingredient utilizing an encapsulated aquaculture premix along with several other protein sources.

### BACKGROUND

Aquaculture is the farming of aquatic organisms such as fish, crustaceans, mollusks and aquatic plants. Aquaculture involves cultivating freshwater and saltwater populations under controlled conditions, and can be contrasted with commercial fishing, which is the harvesting of wild fish. Broadly speaking, capture fisheries can be conceptualized as akin to hunting and gathering while aquaculture is akin to agriculture.

Typically, the finfish and shellfish raised within the aquaculture farms optimally grow and perform while being fed a typical feed that supplies nutrients that the finfish and the shellfish consume in the wild. The original aquaculture feeds were simply fresh or frozen forage fish, but this evolved into use of fish processed and dried into fish meal, which is more practical for formulating into nutritionally balanced feeds that are then fed to the finfish or shellfish. However, due to the global increase of aquaculture production and the limited supply of fish meal, there is a need to develop alternatives to meet the needs of the growing aquaculture industry.

Numerous alternate ingredients have been proposed and evaluated for inclusion in aquaculture feeds. These alternate feed ingredients, or protein sources, include rendered animal products from the meat and poultry industries, plant proteins, insect meals and microbial proteins. However, the nutritional profiles of these alternate protein sources may not match that of fish meal.

Therefore feeding these alternate protein sources by themselves may not provide the ideal nutrition, as compared to the nutrition provided by fish meal, to allow the fish and crustaceans to grow at an optimal rate.

Hence there is a need for supplemental nutrients to be included in balanced feed formulations for fish and shellfish. However, shellfish such as shrimp are slow feeders that locate the feed by smell. Thus, feeds may typically lie submerged in water for extended lengths of time before they are consumed. In addition, shrimp break the feed into small pieces outside their mouth before ingestion. These factors cause the loss of nutrients from feeds due to leaching, which results in lower availability of nutrients to shrimp and this may ultimately compromise growth, health and performance of animals being farmed. In addition, fish such as carp grind feed in the back of their mouth using pharyngeal teeth. Then, the ground particles are consumed. This grinding action within the mouth allows loss of water soluble nutrients from feeds, due to leaching.

It is desirable for the encapsulating matrix to be a digestible substance that will release the encapsulated nutrient during digestion. Proteins and starches are not effective water barriers. Fats are effective moisture barriers, but they melt during the feed manufacturing process. Lecithin is unique fat that is highly digestible, an effective water barrier, and does not melt during feed manufacturing. Previous attempts to encapsulate water soluble components included processes for dissolving lecithin in a solvent followed by the addition of methionine and subsequent evaporation of the solvent or precipitation. Solvents are hazardous and expensive to use.

Hence, there is a need for a protected source of nutrients that are resistant to leaching thereby becoming available to slow feeding animals.

### SUMMARY

In various aspects, this disclosure relates to a premix that reduces leaching of nutrients from feeds and makes them more available to aquatic animals. The disclosure describes a method of manufacturing a granulated or powdered aquaculture premix, a premix for use in an aquatic animal feed, a method of feeding an aquatic animal, a method of preparing a finished feed for larval or juvenile aquatic organisms, and a method of preparing a finished feed in which the leaching rate of an active material is reduced.

In one aspect, the method of manufacturing a granulated or powdered aquaculture feed premix includes generating coated lecithin particles by mixing together deoiled lecithin and a flow aid material. During the mixing process, the deoiled lecithin agglomerates to form particles that are then coated by the flow aid material. In that respect, the flow aid material is present in an amount that is sufficient to coat the nascent lecithin particles, which prevents the particles from sticking to each other. In some embodiments, the deoiled lecithin and the flow aid material are mixed until they form a uniform particulate mixture. Once the particulate mixture has been generated, any number of desired feed ingredients may be added. In some embodiments, one or more water soluble ingredients are added to the particulate mixture. In some embodiments, the water soluble ingredients comprise one or more crystalline amino acids. The intermediate particulate mixture and the water soluble ingredients are then heated to about 25° C. to about 90° C. while continuously mixing for a selected period of time in order to form the granulated or powdered aquaculture feed premix. During this process, the constant heat and mixing causes the coated deoiled lecithin particles to form a matrix that contains, or encapsulates, the water soluble ingredients. By doing so, the matrix significantly reduces the rate at which the water soluble ingredients dissolve when placed in an aqueous environment. In that respect, the premix provided by the present disclosure advantageously keeps most of the water soluble ingredients in the feed until such time as the feed is consumed by an aquatic animal. The reduction in leaching displayed by the premix provided by the present disclosure represents a significant advantage over aquaculture premixes that were known prior to the filing of the instant disclosure.

The present disclosure also relates to an aquaculture feed premix produced by this manufacturing method.

In another aspect, the present disclosure relates to a premix for use in an aquatic animal feed. The premix comprises a matrix comprising a plurality of deoiled lecithin particles coated with a flow aid material; and one or more crystalline amino acids within, or encapsulated by, the matrix. The particles can be formed by the methods disclosed herein including, without limitation, by a mechanical mixing device. In some embodiments, the flow aid material is selected from silica, sand-like materials, talc, silicates, clay-like materials, bentonite, montmorillonite, tapioca starch, potato starch, pea starch, wheat starch, corn starch, flour containing starches, other starch containing materials and combinations of any of the foregoing. The matrix reduces the rate at which the crystalline amino acids dissolve when placed in an aqueous environment. In that respect, the matrix reduces the amount of amino acid leaching away from the premix prior to consumption by the aquatic animal.

In a further aspect, the present disclosure relates to a method of preparing an aquaculture feed for larval or juvenile aquatic organisms. In various embodiments, the methods comprise the generation of a matrix comprising a plurality of deoiled lecithin particles coated with a flow aid material, the matrix encapsulating one or more water soluble ingredients. In this aspect, the feed size (e.g., the size of an individual feed component that is provided to an organism as food) is small in order to accommodate the size of the larval or juvenile animals. In known feed products, leaching losses of the water soluble ingredients are severe because of the small size of the feed itself. The feed provided by the present disclosure overcomes that defect.

The present disclosure also relates to a method of preparing an aquaculture feed in which the leaching rate of the active material away from the feed occurs in a slow or sustained-release process. This is especially useful for slow release of attractant or flavor compounds to assist aquatic organisms in locating submerged feed by smell or chemoreception.

The present disclosure also relates to a method of feeding an aquatic animal, comprising providing the aquatic animal a feed comprising crystalline amino acids within a matrix of deoiled lecithin particles, the matrix reducing the rate at which the crystalline amino acids dissolve into water prior to consumption by the aquatic animal.

### BRIEF DESCRIPTION OF THE DRAWINGS

FIG. 1 is a graphical view of growth rate per week of several dietary treatments.

FIG. 2 is a graphical view showing weight gain of 3 dietary treatments.

FIG. 3 is a graphical view comparing leaching of lysine from protected premix vs. unprotected premix.

### DETAILED DESCRIPTION

The present disclosure relates to a formulation and process for producing a granulated or powdered premix that can be utilized as a component of an aquaculture feed ingredient or an aquaculture feed, as well as premixes prepared by the disclosed process. The process can also be used to produce a granulated feed for larval or juvenile organisms. The granulated or powdered premix comprises a deoiled lecithin matrix that encapsulates water soluble active ingredients that provide nutrition or other benefits to finfish or shellfish being raised in an aquaculture center. The premix, as well as feed products comprising the premix, provide the advantage of retaining a greater weight percent of the active ingredients within the aquaculture feed, relative to other aquaculture feed, when submersed in water. Otherwise stated, the disclosed granulated or powdered encapsulated premix reduces the leaching of the water soluble active ingredients from the premix, or a feed product comprising the premix, into water when submerged.

This a significant improvement over known aquaculture premixes and feeds, which exhibit a significantly greater amount of leaching of the water soluble ingredients or nutrients, thereby preventing aquatic animals from effectively consuming the active ingredients or nutrients and reducing the efficiency of the aquaculture feed. Prior to the submission of the present disclosure, leaching of the nutrients from aquaculture feed into the water was problematic. This was especially problematic when the nutrients are water soluble, such as amino acids, vitamins and the like. The leaching of these ingredients from aquaculture feed constitutes wasting of nutrients intended for consumption by aquatic animals. It is costly to the aquaculturist and problematic to the environment. In that respect, in various aspects the present disclosure relates to premixes and feed that display reduced leaching of nutrients out of the premix and feed and into the water environment. To accomplish this, a matrix comprising coated deoiled lecithin particles is provided that encapsulates water soluble components. The encapsulant serves to reduce leaching of the water soluble components from the matrix, while also presents the water soluble components to aquatic animals for consumption and release during digestion.

In some embodiments, the premix disclosed herein is useful for the generation of feed for an aquatic animal such as shrimp. The mouth of a shrimp is too small to swallow an entire feed pellet. To compensate for this, shrimp typically break feed pellets into small pieces outside the mouth, prior to consumption. Consequently, water soluble nutrients within the feed may leach away from the feed and not be consumed by the shrimp. The premix provided by the present disclosure overcomes this deficit by encapsulating the water soluble nutrients and reducing their water solubility. In doing to, the premix retains the nutrients in the feed, even when pellets are broken into smaller pieces.

In some embodiments, the premix disclosed herein is also useful in the generation of fish feed for finfish, such as carp. A typical finfish, such as a carp, can consume an entire feed pellet. However, carp will typically grind the pellet in their mouth prior to swallowing, thereby exposing the ground portions of the pellet to water such that a portion of the water soluble components in the feed may be lost by leaching away from the feed pellet into the water. The premix provided by the present disclosure overcomes this deficit by encapsulating the water soluble nutrients and reducing their water solubility. In doing to, the premix retains the nutrients in the feed, even when pellets are ground up prior to swallowing by an aquatic animal.

In various aspects, the premix provided by this disclosure can be utilized to generate an aquatic animal feed which contains one or more essential nutrients, such as proteins and fats, necessary to support the dietary requirements of an aquatic animal. In some embodiments, then, the premix disclosed herein can be used to generate a feed that provides supplemental water soluble components, such as amino acids, to an aquatic animal. In additional embodiments, the premix can be utilized to generate a feed that contains one or more attractants in order to induce the aquatic animal to feed on the aquatic animal feed. In that respect, the matrix provided by the premix can serve as a means of slowly releasing the attractant over a period of time. The matrix will encapsulate the attractant which will then display a reduced rate of solubility, allowing the attractant to slowly leach from the feed.

In various aspects, the matrix provided by the premix of the present disclosure comprises fats as the means of reducing the rate of leaching of water soluble components from the disclosed premix or feed. In some embodiments, the fat employed is lecithin; in some embodiments deoiled lecithin is used. In some embodiments, the matrix comprises additional materials in addition to fats, such as proteins, starches, carbohydrates, sterols, hydrocolloid gels and combinations of any of the foregoing. In such embodiments, the additional materials either assist in the reduction of the rate of leaching of the water soluble nutrients from the matrix, or do not interfere in the ability of the matrix to achieve the reduced leaching rate.

In some embodiments, the use of proteins, carbohydrates, sterols, hydrocolloid gels and combinations thereof as additional components can serve to enhance the stability of the matrix comprising deoiled lecithin. Some examples, without limitation, of specific proteins, carbohydrates, sterols and hydrocolloids that can be used to enhance stability of the matrix include:

Proteins—soy protein concentrate, soy protein isolate, corn protein concentrate, fish hydrolysate, squid hydrolysate and combinations of any of the foregoing in an approximate range from about 0.5 to about 1 wt %

Carbohydrates—potato starch, corn starch, rice starch, wheat starch, tapioca starch and combinations of any of the foregoing in an approximate range from about 0.5 to about 3 wt %

Sterols—cholesterol, cholestane, sigmasterol, sitosterol, campestrol, ergosterol and combinations of any of the foregoing in an approximate range from about 0.5 to about 0.8 wt %

Hydrocolloids—Agar, alginate, beta-glucan, galactomannan, carrageenan, guar gum, xanthan gum, carboxymethylcellulose, pectin and combinations of any of the foregoing in an approximate range from about 0.5 to about 2 wt %

One problem with the use of fats as part of the encapsulating material is that fats can melt in mechanical pellet forming equipment such as extruders or pelletizers, since such equipment is capable of generating considerable heat. A solution to this problem that is provided by the present disclosure is the use of deoiled lecithin in the generation of the encapsulating matrix. Deoiled lecithin (sometimes referred to as dry, granular, or granulated lecithin), is not as heat sensitive as commercial lecithin, which is most commonly soybean lecithin, and is capable of maintaining structural integrity at much higher temperatures than commercial grade lecithin. For purposes of this disclosure, the phrase “deoiled lecithin” means that approximately 99% of the soy oil component has been removed to create a waxy substance. Deoiled lecithin typically exists in a granulated form. Deoiled lecithin will soften, but not melt, in mechanical pelletizing equipment because it has the ability to withstand the heat generated by mechanical pelletizing processes such as extrusion or the use of pellet mills. Deoiled lecithin is therefore capable of providing a suitable encapsulating material for purposes of this disclosure.

In contrast, standard fluid soy lecithin does not have the waxy properties of deoiled lecithin and does not produce a suitable encapsulated matrix. The major components of standard soybean-derived lecithin are 33 to 35% soybean oil, 20-21% Inositol phosphatides, 19-21% phophatidyl choline, 8-20% Phosphatidylethanolamine, 5-11% Other phosphatides, 5% Free carbohydrates, 2-5% Sterols and 1% Moisture. (Scholfield, C. R. (October 1981), “Composition of Soybean Lecithin”, Journal of the American Oil Chemists' Society 58 (10): 889-892). The primary sources of lecithin include soybeans (1.48 to 3.08% lecithin), peanuts (1.11%), calf liver (0.85%), wheat (0.61%), oatmeal (0.65%), and eggs (0.39%) (Wood and Allison, Effects of consumption of choline and lecithin on neurological and cardiovascular systems, Life Sciences Research Office, Federation of American Societies for Experimental Biology (FASEB), 1981).

The particle size of a premix produced by the process of this disclosure is about 50 microns to about 200 microns. In some embodiments, a premix comprising particles in the range of about 50 microns to about 200 microns is useful for incorporation into shrimp feed or for use as a complete diet for larval or juvenile organisms.

The present inventors have also discovered that a flow aid material helps in the formation of a suitable granulate or powder premix. In various aspects, a flow aid material is used to coat deoiled lecithin particles, the matrix disclosed herein comprising coated deoiled lecithin particles that encapsulate water soluble nutrients, thereby reducing their water solubility. Non-limiting examples of flow aid materials include silica, sand-like materials such as silicates and talc, clay-like materials such as bentonite and montmorillonite and combinations thereof. These components, when used as a flow aid material, have the advantage of being edible, and thus may be consumed by an aquatic animal, but are also chemically benign and do not have any negative impact on the environment. Other materials suitable for use as flow aid materials include, without limitation, starches such as tapioca starch, potato starch, pea starch, wheat starch, corn starch and starch containing materials such as flour, for example wheat flour. The starch containing materials may also serve as a binder and aid in retaining the shape of the formed granulate or powder after submering. Retaining the shape of the granulate or power has the added advantage of retaining the active ingredients within the granulate or powder. Additionally, the lecithin and starch containing materials also are consumable and considered a source of nutrition for the aquatic animals. Therefore, the starch containing materials are not a source of pollution to the aquaculture site.

The amount of the flow aid material in the premix can vary depending upon the desired properties of the granulated premix. In some embodiments, any combination and weight percent of the flow aid material can be utilized within the disclosed range of weight percent of the flow aid materials in the aquaculture feed premix. In various aspects, the flow aid components provide a coating on the deoiled lecithin particles. It is the flow aid material coated deoiled lecithin particles that make up the premix. As disclosed herein, deoiled lecithin is the primary component, by weight, of the premix. During production of the matrix, it was discovered that the use of deoiled lecithin alone caused the particles to cling to each other. To avoid this, the flow aid materials are utilized to coat the lecithin particles as they are nascently forming, in order to prevent the particles from sticking to each other, which helps form a unitary mass of lecithin in the matrix.

In some embodiments, the formulation of the encapsulated granulated or powdered premix comprises about 20 wt. % to about 50 wt. % encapsulating materials, about 20 wt. % to about 50 wt. % active ingredients and about 10 wt. % to about 30 wt. % flow aid materials. Examples of the encapsulating materials in addition to deoiled lecithin include, but are not limited to, combinations of phospholipids with triglycerides, stearates, emulsifying agents, sterols, and hydrocolloid gels such as, but not limited to, alginate and carrageenan. Depending upon the desired properties of the granulated premix, any combination and weight percent of encapsulating materials can be utilized within the disclosed range of weight percent of the encapsulating materials.

In one embodiment, an aquaculture premix comprises the following components:

| | Weight % of |
|---|---|
| Component | Product |
| Deoiled Lecithin | 37-54 |
| Water Soluble Nutrients/Amino Acids | 38-54 |
| Precipitated Silica | 3-7 |
| Starch | 1-5 |
| Bentonite | 1-5 |

The active ingredients of the premix include one or more water soluble components. Examples of water soluble ingredients for use in the aquaculture feed premix of this disclosure include, but are not limited to, amino acids, vitamins, minerals, attractant compounds, pigments, sterols, nucleotides, medications, and bioactive compounds. In some embodiments, the active ingredients comprise crystalline amino acids.

The use of plant derived proteins, such as proteins derived from soybeans, is becoming increasingly popular in aquaculture replacing traditional fish protein or terrestrial animal protein in known fish meal, thereby reducing the overall cost of production. However, soybean derived proteins are deficient in some amino acids such as methionine lysine and threonine. To provide the aquatic animal with a balanced amino acid formulation, the protein derived from soybeans may be supplemented for those amino acids that are missing. Crystalline amino acids such as methionine, lysine and threonine which are commercially available and made either through the use of genetically modified bacteria or by chemical synthesis, can be added to the aquatic animal feed. Prior to this disclosure, such supplemental amino acids were lost at a significant rate when the aquatic feed was submerged in water. In view of this, past supplementation with crystalline amino acids did not produce the desired growth effects in the aquatic animal. As described herein, the premix provided by the present disclosure can overcome this problem by significantly reducing the rate of leaching of these amino acids away from the premix.

The premix of this disclosure may also comprise one or more bioactive compounds which may, for example, modulate growth and the physiology of aquatic animals, such as shrimp. Attractant compounds may also be incorporated into the premix and are utilized to attract the aquatic animal to the feed, thereby increasing feed consumption. Attractants are especially useful to induce shrimp to eat the feed. In some embodiments, the encapsulating material slowly releases the attractant into the surrounding environment. The slow rate of release increases the length of time the attractant is present around the feed, which increases the likelihood of more of the feed being consumed. Suitable compounds for an attractant that will elicit responses from crustaceans and other aquatic animals include without limitation: nucleotides, nucleosides, nucleic acids, free amino acids, amines and quaternary amines, biogenic amines, organic acids, fatty acids, phospholipids, sugars and combinations of any of the foregoing. A suitable attractant for both fish and crustaceans is Aqua Savor® which is manufactured by Bentoli, of Elgin, Tex.

The granulated premix is formed by combining the desired encapsulating materials, such as, for example, deoiled lecithin, with the desired flow aid materials, such as, for example, precipitated silica. In some embodiments, the amount of flow aid material is significantly less than the amount of encapsulant, resulting in only a light coating of flow aid material on the nascent encapsulant particles. The encapsulating materials and flow aid materials can be mixed together in a mixer, such as, but not limited to, a bench-top mixer, an edge runner mill, a triple roll mill, a silent cutter, an extruder, or other high shear mixing device, to form the granulated or powdered premix. In some embodiments, after the encapsulating materials and flow aid materials have been mixed, the granulated or powdered premix may be extruded from the mixing device by a twin screw extruder. In some embodiments, the encapsulating materials and flow aid materials are mixed for about ten minutes to about thirty minutes in order to prepare the flow aid material-coated deoiled lecithin particles.

Once the flow aid material-coated deoiled lecithin particles have been generated, the desired water soluble active ingredients are added. The combined active ingredients, encapsulating materials and flow aid materials are then mixed and/or kneaded for about ten minutes to about thirty minutes at a temperature range of about 25° C. to about 90° C.

Upon the expiration of the selected mixing time, the final product is either a granule or a powdered form of premix, where the active ingredients are encapsulated within a matrix of flow aid material-coated deoiled lecithin particles. In some embodiments, a small amount of water may be added to the mixture during the generation of the flow aid material-coated deoiled lecithin particles, in order to form a uniform mass of matrix material which can be pelletized, dried, and ground to form the granular material. As shown in Example 3, when feeds containing an encapsulated product, generated according to the methods provided by the present disclosure, were submerged in water for about one hour, 38 weight % of the encapsulated nutrients were lost through leaching. In contrast, when the same formulation that was not encapsulated using the disclosed process was submerged for 1 hour, about 55 weight % to about 68 weight % of the active ingredients were leached away from the formulation. As such, the encapsulated premix advantageously provides more nutrition to the aquatic animals and therefore provides a more efficient and economically viable product relative to a premix that does not utilize the disclosed method of producing the premix.

Other features of the subject matter provided by the present disclosure will become apparent in the course of the following description of exemplary embodiments which are given for illustration purposes only and are not intended to be limiting in any way.

### EXAMPLES

### Example 1

A 6 week trial was conducted to compare growth rates of Pacific White shrimp fed 6 different diets. The average initial weight of each shrimp was 2.79 grams. A total of 30 to 40 shrimp were placed in each tank (approximately 750 liters/tank). Each dietary treatment consisted of five replicate tanks.

The five dietary treatments were as follows:
1. FM CTRL: a fishmeal control containing 25% fishmeal with the remainder being soybean meal and wheat flour.
2. AQPK: Fishmeal free with Aqua-Pak** and protected premix of this disclosure.
3. AQPK UP: Fishmeal free with Aqua-Pak** and unprotected premix;
4. AQPK NP: Fishmeal free with Aqua-Pak** and no premix
5. COMM: Commercial shrimp feed***.

The tabulated results of this trial are included in Table 1 below:

TABLE 1

| | | Weight | Growth rate, |
|---|---|---|---|
| Diets | Description | Gain, g | g/wk |
| FM CTRL | Fishmeal Control; 25% | 15.58 ± 0.90 | 2.64 ± 0.15 |
| | Fish Meal | | |
| AQPK | Fishmeal Free; AquaPak** | 15.54 ± 0.73 | 2.59 ± 0.15 |
| | with protected premix | | |
| AQPK UP | Fishmeal Free; AquaPak** | 14.50 ± 0.47* | 2.41 ± 0.08* |
| | with unprotected premix | | |
| AQPK NP | Fishmeal Free; AquaPak** | 14.25 ± 1.05* | 2.37 ± 0.17* |
| | with no premix | | |
| COMM | Commercial shrimp | 15.63 ± 1.41 | 2.60 ± 0.24 |
| | feed*** | | |

*Significant p < 0.05; Duncan's test
**AQUA-PAK fishmeal replacer for shrimp produced by H. J. Baker & Bro., Inc of Little Rock, Arkansas
***Llocally available generic shrimp feed.

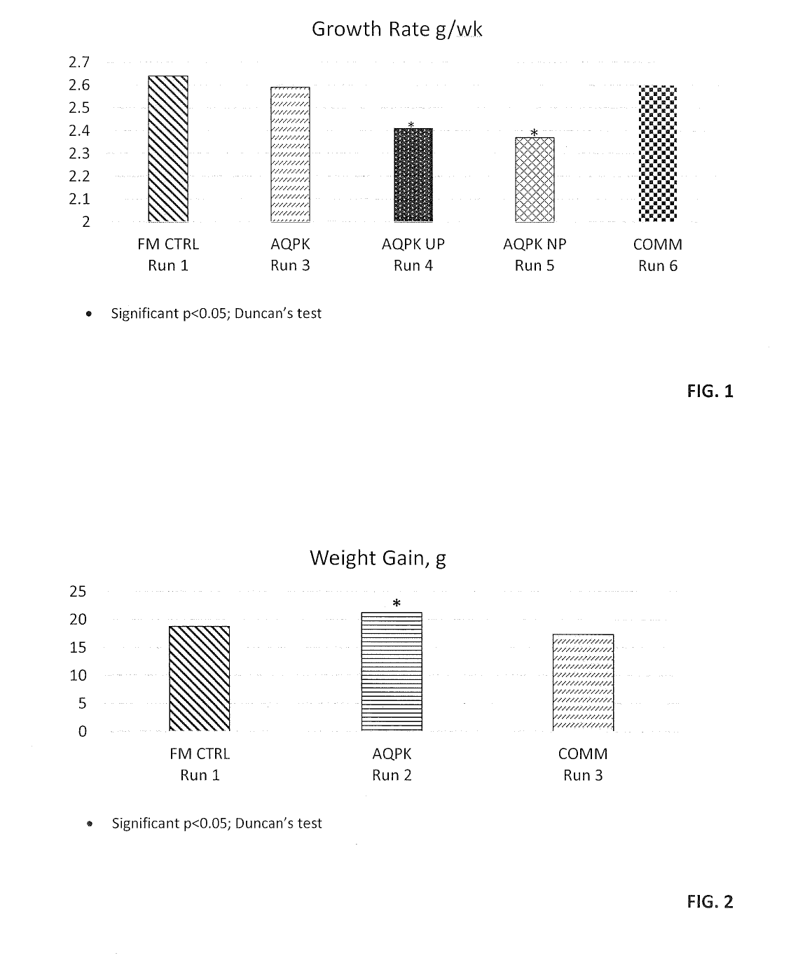

The growth rate results in Table 1 are also illustrated in FIG. 1 in graphical form. As illustrated in FIG. 1 and shown in Table 1 above, the growth rate and the weight gain of the shrimp fed using the premix of this disclosure performed significantly better than Treatment 3 (unprotected premix, wherein the premix did not include the encapsulating material of this disclosure) and Treatment 4 (no premix, wherein no premix was added to the feed)

### Example 2

An 8 week trial was conducted to compare growth rates of Pacific White shrimp with 3 different dietary treatments, each treatment using a different type of feed and then measuring the weight gain of the shrimp. The average initial weight of each shrimp was about 3.25 grams. A total of 30 to 40 shrimp were placed in each tank (approximately 750 liters/tank) with 9 replicate tanks per dietary treatment.

The 3 dietary treatments were as follows:
1. FM CTRL: a fishmeal control containing 25% fishmeal with the remainder being soybean meal and wheat flour.
2. AQPK: Fishmeal free with Aqua-Pak* and protected premix of this disclosure.
3. COMM: Commercial shrimp feed**.

The tabulated results of this trial are included in Table 2 below:

TABLE 2

| | | Weight | Growth rate, |
|---|---|---|---|
| Diets | Description | Gain, g | g/wk |
| FM CTRL | Fishmeal Control; 25% | 18.58 ± 1.89 | 2.35 ± 0.24 |
| | Fish Meal | | |
| AQPK | Fishmeal Free; AquaPak** | 21.23 ± 4.83* | 2.65 ± 0.60* |
| | with protected premix | | |
| COMM | Commercial shrimp | 17.35 ± 4.65 | 2.17 ± 0.58 |
| | feed***, 45% CP | | |

*Significant p < 0.05; Duncan's test
**AQUA-PAK fishmeal replacer for shrimp produced by H. J. Baker & Bro., Inc of Little Rock, Arkansas
***Locally available generic shrimp feed.

The results are also illustrated in FIG. 2. As illustrated in FIG. 2 and Table 2, the weight gain and growth rate of the shrimp fed with the premix of this disclosure (AQPK) gained more weight and had a greater overall growth rate per week than the control group, or the group fed commercially available feed.

### Example 3

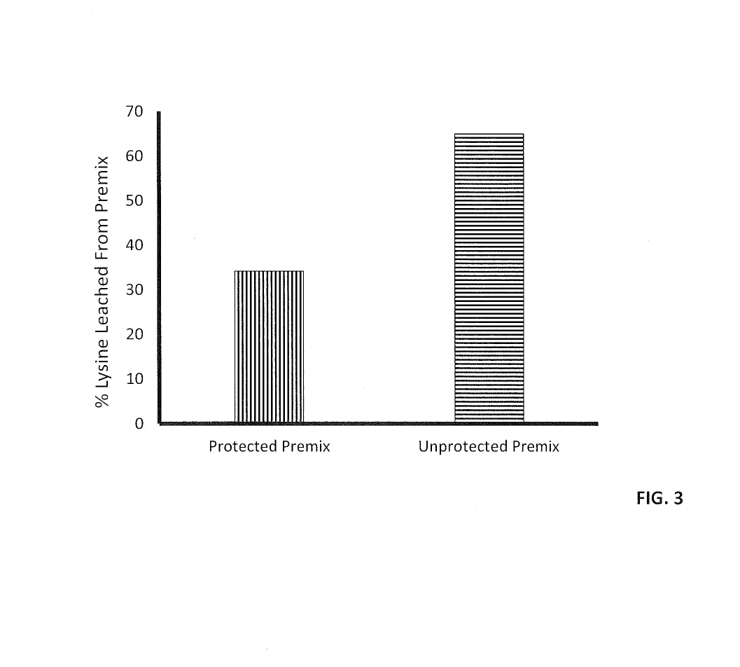

A comparative trial was run to compare leaching results of samples prepared using the encapsulating process of this disclosure as compared samples prepared without the encapsulating process disclosed herein. Both premixes included lysine at 0.5% by weight; lysine was selected because it is readily soluble in water. The premixes were immersed in water for approximately 1 hour and then measured for retained lysine. The results are shown in FIG. 3. The data show that only 38% of lysine leached out of the “protected premix” samples of this disclosure while 55 to 68% of the lysine leached from the “unprotected premix,” that is a feed without the encapsulation disclosed herein. The results show that the disclosed encapsulation process significantly reduces leaching of water soluble nutrients from the premix provided by the present disclosure.

Although the present disclosure references preferred embodiments, workers skilled in the art will recognize that changes may be made in form and detail without departing from the spirit and scope of the subject matter disclosed herein.

1. A method of manufacturing an aquaculture feed premix, comprising:
generating coated lecithin particles by mixing deoiled lecithin and a flow aid material;
adding one or more water soluble ingredients to the coated lecithin particles; and
heating the coated lecithin particles and the water soluble ingredients to about 25° C. to about 90° C. while continuously mixing;
wherein the coated lecithin particles form a matrix that encapsulates the one or more water soluble ingredients.

2. The method of claim 1, wherein the deoiled lecithin comprises about 20 wt. % to about 50 wt. % of the total weight of the premix.

3. The method of claim 1, wherein the water soluble ingredients comprise about 20 wt. % to about 50 wt. % of the total weight of the premix.

4. The method of claim 1, wherein the water soluble ingredients are selected from amino acids, vitamins, minerals, attractant compounds, pigments, sterols, nucleotides, bioactive compounds and combinations thereof.

5. The method of claim 1, wherein the water soluble ingredients comprise one or more crystalline amino acids.

6. The method of claim 1, wherein the flow aid materials comprise about 10 wt. % to about 30 wt. % of the total weight of the premix.

7. The method of claim 1, wherein the flow aid materials are selected from silica, sand-like materials, clay-like materials, starches, starch containing materials and combinations thereof.

8. The method of claim 7, wherein the sand-like materials are selected from talc, silicates and a combination thereof.

9. The method of claim 7, wherein the clay-like materials are selected from bentonite, montmorillonite and a combination thereof.

10. The method of claim 7, wherein the starches comprise tapioca starch, potato starch, pea starch, wheat starch, corn starch, flour or combinations thereof.

11. The method of claim 1, wherein the deoiled lecithin and the flow aid materials are mixed for about ten minutes to about thirty minutes.

12. The method of claim 1, wherein the coated lecithin particles and the water soluble ingredients are mixed for about ten minutes to about thirty minutes.

13. The method of claim 1, wherein the method is performed in a high shear mixing device.

14. The method of claim 13, wherein the high shear mixing device comprises a bench top mixer, an edge runner mill, a triple roll mill, a silent cutter, or an extruder.

15. An aquaculture feed premix produced by the method of claim 1.

16. A method of feeding an aquatic animal, comprising:
providing the aquatic animal a feed comprising crystalline amino acids within a matrix of deoiled lecithin particles, the matrix reducing the rate at which the crystalline amino acids dissolve into water prior to consumption by the aquatic animal.

17. The method of claim 16, wherein the aquatic animal is a shrimp or a carp.

18. The method of claim 16, wherein the deoiled lecithin particles are coated with silica, sand-like materials, talc, silicates, clay-like materials, bentonite, montmorillonite, tapioca starch, potato starch, pea starch, wheat starch, corn starch, flour containing starches, other starch containing materials or combinations thereof.

19. A premix for use in an aquatic animal feed, comprising:
a matrix comprising a plurality of deoiled lecithin particles coated with a flow aid material; and
one or more crystalline amino acids within the matrix.

20. The premix of claim 19, wherein:
the flow aid material is selected from silica, sand-like materials, talc, silicates, clay-like materials, bentonite, montmorillonite, tapioca starch, potato starch, pea starch, wheat starch, corn starch, flour containing starches, other starch containing materials and combinations thereof; and
the matrix reduces the rate at which the crystalline amino acids dissolve into water.

21. A premix for use in an aquatic animal feed, comprising:
deoiled lecithin in an amount of approximately 37-54 wt %;
water soluble nutrients in an amount of approximately 38-54 wt %;
precipitated silica in an amount of approximately 3-7 wt %;
starch in an amount of approximately 1-5 wt %; and
bentonite in an amount of approximately 1-5 wt %.

22. The premix of claim 21, wherein the water soluble nutrients are one or more amino acids.
